(19) United States
(12) Patent Application Publication
(10) Pub. No.: US 2005/0231458 A1
(43) Pub. Date: Oct. 20, 2005

(54) Liquid crystal display television, backlight control device, and backlight control method

(75) Inventor: Takeshi Miki, Osaka (JP)

Correspondence Address: Yokoi & Co., U.S.A., Inc., #1512, 13700 Marina Pointe Drive, Marina Del Rey, CA, 90292, US

(73) Assignee: Funai Electric Co., Ltd., Osaka (JP)

(21) Appl. No.: 11/092,647

(22) Filed: Mar. 29, 2005

(30) Foreign Application Priority Data
Mar. 30, 2004 (JP) JP2004-098694

(51) Int. Cl. G09G 3/36

(52) U.S. Cl. 345/102

(57) ABSTRACT

Conventionally, it is difficult to adjust the luminance of an LCD panel suitable for viewing a movie image. According to this invention, when a black belt detection circuit detects a black belt added above and below an image to be viewed, such as a letter box type video signal, a microcomputer generates a pulse signal P with a predetermined duty ratio, as a control signal to cause an inverter to lower the luminance of a backlight. Said inverter in turn change the duty ratio of a drive pulse output from a switching circuit based on said pulse signal, and the backlight decreases its luminance, making the luminance of the LCD panel suitable for viewing a movie image. Moreover, it is possible to display an image as it is based on an input image signal, thus allowing the original gray scale of the input video signal to be reproduce faithfully on the screen.

### BAKGROUND OF THE INVENTION

1. Field of the Invention

This invention relates to a liquid crystal display (hereinafter, called LCD) television, a backlight control device, and a backlight control method.

2. Description of the Prior Art

Conventionally, when viewing a movie on a television, brightness of the screen of the television is adjusted to lower the brightness, by operating a brightness control in the user mode or the like so as to make the brightness suitable for viewing a movie.

As a prior art, a projection-type display apparatus is well known, wherein the power to be supplied to a light source means is controlled by calculating a black level offset, based on the illuminance of a projected image calculated from the area of an image projected onto the screen and a light flux projected from a light source lamp and passing through a projection lens, and the illuminance of the screen near the projected image (as an instance, refer to the Patent document 1: Japanese Patent Laid-open No. 2002-250906).

Said projection type display apparatus increases or decreases the power to be supplied to the light source means, based on a difference between the illuminance of a projected image and the illuminance of the screen near the projected image area.

With the conventional screen luminance adjustment described above, a brightness adjustment for viewing a movie with an appropriate brightness is made by performing a predetermined signal processing, such as reducing the brightness, for an input video signal. Adjusting a video signal itself in this way may cause the gray scale of a displayed image to be deteriorated compared with an image originally intended by the input video signal.

Also, with a projection type display apparatus disclosed in the above Patent document 1, adjustment of the output of a light source means is made based on the illuminance of said projected image and that of the screen near the projected image area. Therefore, there is a problem of being unable to adjust the output of a light source based on the characteristics of a video signal the image display apparatus intends to display.

### SUMMARY OF THE INVENTION

This invention has been made in view of the problem mentioned above, and therefore an object of this invention is to provide an LCD television, backlight control device, and backlight control method which allows adjustment of the brightness of an LCD panel to an optimum brightness for viewing a movie.

To achieve this object, an LCD television according to this invention comprises: an LCD panel with a predetermined aspect ratio and with the display surface formed by a plurality of pixels; a backlight disposed behind said LCD panel to illuminate the display surface of said LCD panel from behind; an inverter to light said backlight at a predetermined luminance by applying a voltage to said backlight; a video signal processing circuit to perform a predetermined signal processing for an input video signal; an LCD drive circuit 30 to display an image on said LCD panel based on said video signal; and a microcomputer to control each of said components, wherein said backlight is a fluorescent lamp; said video signal processing circuit is equipped with a black belt detection circuit to detect a black belt added above and below a landscape image whose aspect ratio is different from said LCD panel, based on the degree of change in luminance of each pixel detected by scanning predetermined vertical scanning lines in a video signal for one frame; said microcomputer, when said black belt is detected by the black belt detection circuit, generates a pulse signal having a predetermined duty ratio and causes said inverter to decrease the luminance of a fluorescent lamp and transmits the pulse signal to said inverter; and said inverter decreases the luminance of said fluorescent lamp down to a luminance suitable for viewing an image with said black belts above and below, by changing the output of an AC voltage supplied to said fluorescent lamp based on said pulse signal transmitted from the microcomputer.

An LCD television constructed as above according to this invention comprises: an LCD panel with a predetermined aspect ratio and with the display surface formed by a plurality of pixels; a backlight disposed behind said LCD panel to illuminate the display surface of the LCD panel from behind; an inverter to light said backlight at a predetermined luminance by applying a voltage to said backlight; a video signal processing circuit to perform a predetermined signal processing for an input video signal; an LCD drive circuit to display an image on said LCD panel based on said video signal; and a microcomputer to control each of said components.

Here, said video signal processing circuit is equipped with a black belt detection circuit by which said black belt is detected from an input video signal. That is, when viewing an image that is larger in width than the aspect ratio of an LCD panel, such as a letter box type image with an aspect ratio of 16:9, a black belt is added above and below the image. It is possible to determine the type of an image generated from an input video signal, by detecting said black belt. Specifically, predetermined vertical scanning lines in a video signal for one frame are scanned, and it is determined whether or not said black belt is added based on the degree of change in luminance of each pixel detected by said scanning.

Said microcomputer, when said black belt is detected by said black belt detection circuit, generates a pulse signal with predetermined duty ratio to cause said inverter to decrease the luminance of a fluorescent lamp, and transmits the pulse signal to said inverter. Said inverter receives the pulse signal transmitted from the microcomputer, and change the output of an AC voltage supplied to the fluorescent lamp serving as a backlight, based on said pulse signal. As a result, the luminance of said fluorescent lamp is decreased down to a an luminance suitable for viewing an image with a black belt above and below. An image with a black belt above and below is typically used for a movie image. Therefore, with the construction according to this invention, it is possible to decrease the luminance of the LCD panel down to an optimum luminance for viewing said movie image, when viewing a movie on an LCD television.

Furthermore, a backlight control device disposed at a predetermined position in a LCD panel for controlling the backlight that illuminates said LCD panel from behind may have a backlight control circuit that changes the luminance of said backlight at a predetermined degree when displaying a landscape image with an aspect ratio different from said LCD panel and with a black belt added above and below the image.

With the above construction according to this invention, the backlight control device controls the backlight that is disposed at a predetermined position in the LCD panel and illuminates the LCD panel from behind.

Here, the backlight control circuit changes the luminance of said backlight at a predetermined degree upon receipt of a video signal displaying a landscape image with an aspect ratio different from the LCD panel and with a black belt added above and below the image. A video signal having a black belt above and below is typically used for a movie image. Therefore, employing the construction according to this invention allows the luminance of the LCD panel to be automatically adjusted to an optimal brightness for viewing said movie image.

Moreover, said backlight control circuit may have a black belt detection circuit to detect said black belt, and said black belt detection circuit scans predetermined vertical scanning lines in a video signal to detect the luminance of each pixel, and determines whether or not said black belt is included in a video signal, based on the degree of change in luminance detected between pixels.

Providing said black belt detection circuit allows the backlight control circuit to automatically determine whether or not a video signal includes said black belt. Specifically, the backlight control circuit scans predetermined vertical scanning lines in a video signal to detect the luminance of each pixel, and determines whether or not said black belt is included in the video signal based on the degree of change in luminance detected between pixels. That is, if a video signal has a black belt above and below, a predetermined number of pixels above and below the video signal have basically the lowest luminance, and consequently said black belts can be easily detected if the degree of change in luminance is observed by scanning the vertical scanning lines.

Furthermore, said backlight control circuit may have a microcomputer and an inverter, wherein said microcomputer generates a control signal to decrease the luminance of the backlight and transmits the control signal, when said black belt is detected by said black belt detection circuit, and said inverter decreases the luminance of the backlight based on said control signal.

With the above construction according to this invention, the backlight control circuit has a microcomputer and an inverter. The microcomputer generates a control signal to decrease the luminance of the backlight when said black belt is detected by the black belt detection circuit, and transmits the control signal generated to the inverter, which in turn decreases the luminance of the backlight based on said control signal.

Also, said microcomputer may generate a pulse signal with a predetermined duty ratio when said black belt is detected by said black belt detection circuit, and said inverter changes the output of an AC voltage supplied to the backlight to lower the luminance of the backlight, based on said pulse signal.

With the above construction according to this invention, the microcomputer generates a pulse signal with a predetermined duty ratio when said black belt is detected by the black belt detection circuit. The inverter receives said pulse signal and changes the output of an AC voltage supplied to the backlight to decrease the luminance of the backlight, based on said pulse signal. This causes the luminance of the backlight to change to an optimal luminance for viewing a movie image or the like.

Said backlight is a fluorescent lamp. Since the fluorescent lamp lights up on an AC voltage supplied by the inverter, the luminance of the fluorescent lamp can be changed easily by controlling the output of the inverter using a pulse signal generated by the microcomputer.

So far, technical concepts for changing the luminance of a backlight for an LCD panel have been described in the form of the invention of an apparatus to realize the concepts. However, these technical concepts are true of the invention of a method of realizing the same. Therefore, this invention may be a method of controlling a backlight that is disposed at a predetermined position in an LCD panel and illuminates said LCD panel from behind, and it is possible to change the luminance of said backlight at a predetermined degree when displaying a landscape image with an aspect ratio different from said LCD panel and with a black belt added above and below the image, on said LCD panel.

Needless to say, the invention of a method can be understood in each embodiment of this invention.

As described above, according to this invention, the brightness of the LCD panel can be easily adjusted to a brightness suitable for viewing a movie image by lowering the luminance of the backlight, when viewing said movie image with a black belt added above and below. Moreover, since the signal processing is not required for the luminance adjustment for an input video signal, the original gray scale of an input video signal can be faithfully reproduced on the screen.

### BRIEF DESCRIPTION OF THE DRAWINGS

FIG. 1 is a schematic block diagram of an LCD television according to one embodiment of this invention.

FIG. 2 is an explanatory diagram showing a movie image displayed on an LCD panel.

FIG. 3 is a flowchart of a pulse signal generation processing.

FIG. 4 is a block diagram showing a backlight and a microcomputer.

### DESCRIPTION OF THE PREFERRED EMBODIMENTS

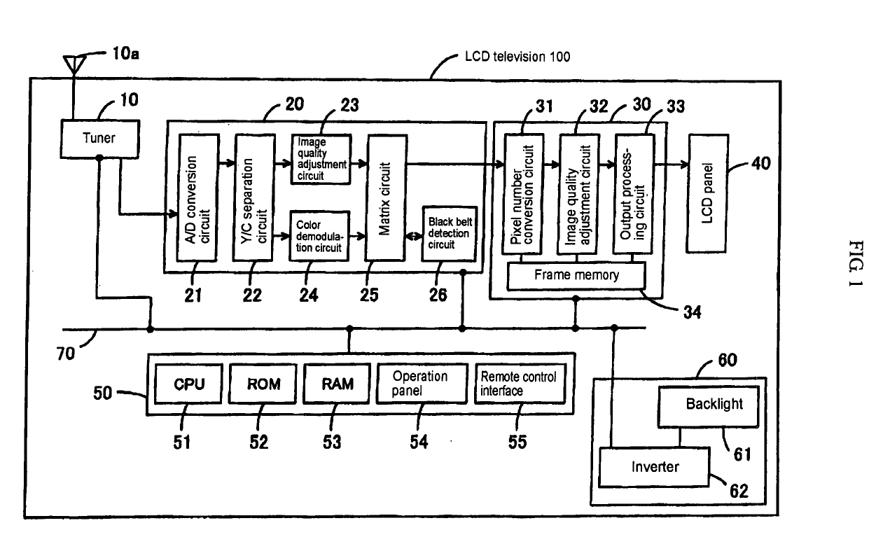

FIG. 1 shows a basic configuration of an LCD television according to one embodiment of this invention.

As shown in the figure, an LCD television 100 basically comprises a tuner 10; an RGB signal generation circuit 20; an LCD drive circuit 30; an LCD panel 40; a microcomputer 50; and a backlight unit 60. In this configuration, the microcomputer 50 is connected to each component of the LCD television 100 via an IIC bus 70 and a CPU 51 controls the entire LCD television 100 according to each program written in memory including a ROM 52 and a RAM 53. The microcomputer 50 is connected to an operation panel 54 and a remote control interface 55 and can control various processing in the LCD television by means of an input signal through said operation panel 54 and an input signal from a remote control through the remote control interface 55.

The tuner 10 receives a television broadcasting signal through an antenna 10a under the control of the microcomputer 50. Then, the tuner 10 performs a predetermined signal amplification processing, and at the same time extracts a composite video signal as an IF signal from the received television broadcasting signal and outputs the composite video signal to an A/D conversion circuit 21 in the RGB signals generation circuit 20. The A/D conversion circuit 21 converts the input composite video signal to a digital signal according to the level of that signal. The composite video signal converted to a digital signal is typically processed as follows: a Y/C separation circuit 22 separates a luminance signal and a chrominance signal from the digitized composite video signal. The separated luminance signal is input to an image quality adjustment circuit 23 for a predetermined adjustments including a signal amplification processing, and then output to a matrix circuit 25. Meanwhile, the separated chrominance signal is demodulated to R-Y and B-Y color-difference signals in a color demodulation circuit 24, and then output to the matrix circuit 25.

The matrix circuit 25 performs an matrix conversion processing based on the input luminance signal and chrominance signal to generate RGB (red, green, blue) signals as image data. In this embodiment, the RGB signal generation circuit 20 is equipped with a black belt detection circuit 26. Said black belt detection circuit 26 detects the luminance level of an RGB signal output from the matrix circuit 25 and detects whether or not a black belt with a low luminance level is included at a predetermined area in an image. This detection will be described later.

The RBG signals are then output to the LCD drive circuit 30. The LCD drive circuit 30 comprises a pixel number conversion circuit 31; an image quality adjustment circuit 32; an output processing circuit 33; and a frame memory 34. The pixel number conversion circuit 31 inputs said RGB signals and generates RGB signals for one frame to be displayed on the LCD panel 40 while scaling the RGB signals, and then stores the RGB signals for one frame in the frame memory 34 as pixel information.

The image quality adjustment circuit 32 adjusts brightness, contrast, black balance, and white balance for the RGB signals that have been scaled in the pixel number conversion circuit 31 and stored in the frame memory 34. However, since the luminance adjustment of the LCD panel 40 is made by controlling a backlight 61 according to this invention, the processing for changing the luminance of the LCD panel 40 by adjusting the gray scale value itself of the RGB signal, such as the brightness adjustment in said image quality adjustment circuit, will not be required. The output processing circuit 33 generates a control signal voltage based on a synchronization signal output from a synchronizing circuit (not shown) and said RGB signals, and drives an LCD panel for R (red), an LCD panel for G (green), and an LCD panel for B (blue) of the LCD panel 40 according to the pixel and color.

The backlight unit 60 comprises the backlight 61 serving as a light source to illuminates the LCD panel 40 from behind and the inverter 62 that supplies said AC voltage to the backlight 61 to light the same. In this embodiment, the backlight 61 is a fluorescent lamp and the inverter 62 is connected to the microcomputer 50. The inverter 62 receives a pulse signal P as a control signal from the microcomputer 50, and changes the duty ratio of the AC voltage to be applied to the backlight 61 based on said pulse signal P. When the AC voltage whose duty ratio has been changed based on said pulse signal P is applied to the backlight 61, the luminance of the backlight 61 changes as described later.

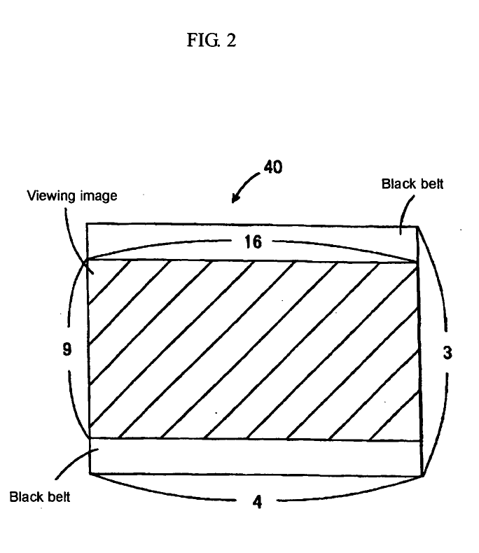

FIG. 2 shows a movie image displayed on the LCD panel 40. In this embodiment, the LCD panel 40 has an image display surface with an aspect ratio of 3:4. For the so called letter box type image, however, a black belt is added above and below the image with an aspect ratio of 9:16, thereby to make the aspect ratio of this type of image 3:4. Typically, the video signal for a movie image is configured assuming that the movie image is viewed at the brightness of a movie theater, and therefore, the luminance to be set for viewing an image displayed on a television screen may be felt too bright when viewing the movie image. Also, when viewing a movie image, it is possible to reproduce a delicate film-quality image by lowering the luminance to soften the entire image.

In this embodiment, therefore, when the LCD television 100 displays an image by means of a video signal consisting of an image with an aspect ratio different from the LCD panel 40 and with a black belt added above and below the image, the luminance of the LCD panel 40 is adjusted to an optimal brightness for viewing the movie image by lowering the luminance of the backlight 61 down to a predetermined level.

Now, the processing by the black belt detection circuit 26 will be described below.

The black belt detection circuit 26 obtains the luminance of each pixel by scanning a predetermined vertical scanning lines, for said RGB data for one frame. If the luminance of a predetermined number of pixels from the top and bottom of the screen respectively is detected to be “0” or less than a predetermined threshold value approximate to zero, the black belt detection circuit generates a black belt detection signal and outputs this signal to the microcomputer 50, assuming that said black belts are detected.

Alternatively, the black belt detection circuit 26 may detect said black belts by detecting the edge appearing at the border between a black belt and an image to be viewed. That is, since the luminance obtained from the pixels displaying a black belt is basically “o”, the luminance changes sharply at said border. Therefore, in scanning of the predetermined number of vertical scanning lines, if said edge is detected at a predetermined position in the top and bottom areas of the screen based on the degree of change in luminance, it may be determined that said black belts are detected. In addition, a well known edge detection filter such as the Laplacian filter can be used for detecting this edge.

It is also possible to change the luminance of the backlight 61 based on the judgment of the viewer of the image, instead of the automatic detection by the black belt detection circuit 26. That is, a “standard mode” and a “movie mode” may be provided that allow the viewer to specify the luminance of the LCD panel 40. When said movie mode is specified through the remote control or the operation panel 54, a signal corresponding to said black belt detection signal is sent to the CPU via the remote control interface 55 or the operation panel 54.

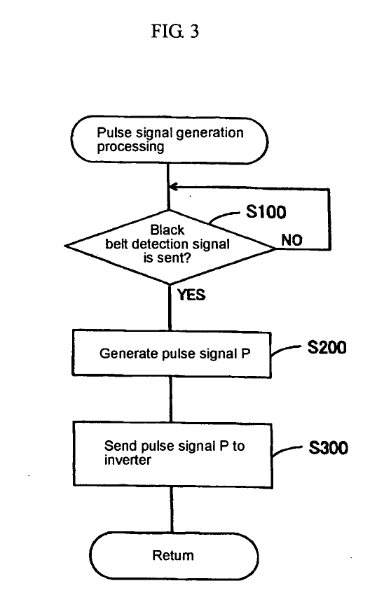

FIG. 3 shows a flow of the pulse signal generation processing by the microcomputer 50.

The microcomputer 50 monitors whether or not a black belt detection signal is sent from the black belt detection circuit 26, a remote control interface 55, or the operation panel 54 (Step S100). If the black belt detection signal is not sent, the microcomputer 50 does not perform the backlight control processing according to this invention and continues to monitor. If a black belt detection signal is sent, the microcomputer 50 generates a pulse signal P with a predetermined duty ratio (Step S200). The duty ratio refers to the ratio of high (H) levels to the frequency of a pulse signal. The pulse signal P is a control signal for the inverter 62 that supplies an AC voltage to the backlight 61. The AC voltage supplied to the backlight by the inverter 62 changes as the duty ratio is changed. In this embodiment, the microcomputer 50 generates the pulse signal P to cause the inverter 62 to lower the luminance of the backlight 61, in Step S200.

Then, the microcomputer 50 sends said pulse signal P to the inverter 62 (Step S300). The duty ratio of the pulse signal P that determines the degree of decrease in luminance of the backlight 61 can be freely set by the viewer through a remote control or the operation panel 54.

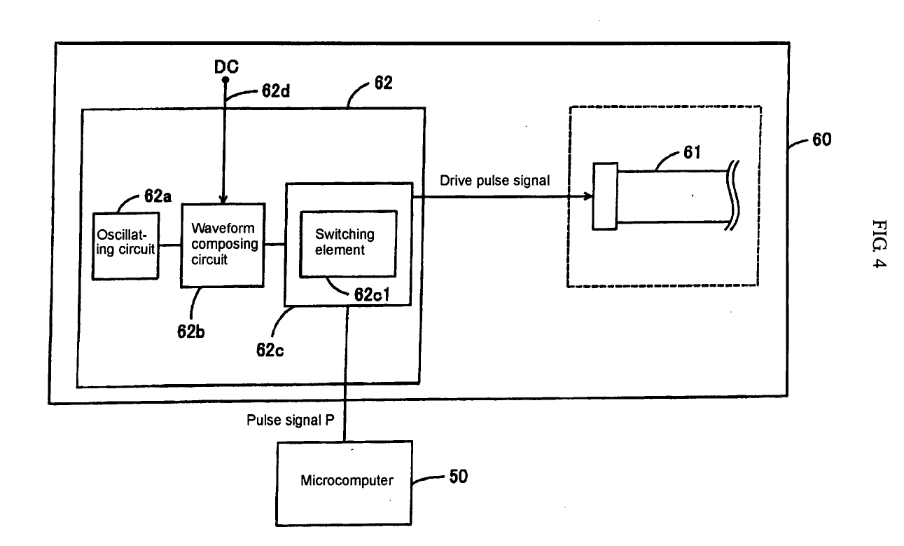

FIG. 4 is a block diagram showing the backlight unit 60 and the microcomputer 50.

In the figure, the inverter 62 comprises an oscillating circuit 62a; a waveform composing circuit 62b; and a switching circuit 62c. The inverter 62 receives a DC voltage through a power line 62d. Said DC voltage is supplied from a power supply circuit (not shown), which converts a utility AC power to a DC voltage to drive the entire LCD television 100. Said DC voltage is composed, in the waveform composition circuit 62b, with a predetermined oscillation signal generated in the oscillating circuit 62a, and then output to the switching circuit 62c. Said switching circuit 62c converts the input DC voltage to a drive pulse signal to output it to the backlight 61.

That is, the switching circuit 62c outputs the drive pulse signal by switching on or off a switching element 62c1 for the DC current input to the switching circuit 62c. The drive pulse signal output from the switching circuit 62c is applied to an electrode of the backlight 61 that is a fluorescent lamp to light the backlight 61. Here, the luminance of the backlight 61 lit by the drive pulse signal is determined by the duty ratio of said drive pulse signal. The backlight 61 lights when the signal level of the drive pulse is H level and does not light at low (L) level. Accordingly, the luminance of the backlight is determined by the ratio of the H and L levels of the supplied drive pulse signal, and therefore the luminance of the backlight 61 increases as the duty ratio of the drive pulse signal increases and vise versa.

The luminance of the backlight 61 can be changed by changing the duty ratio of said drive pulse. Specifically, a control signal to change the timing at which the switching circuit 62c switches the switching element 62c1 is provided to the inverter 62. Then, as described above, the microcomputer 50 sends the pulse signal P to the switching circuit 62c, as the control signal for the inverter 62.

When said pulse signal P is provided to the switching circuit 62c, this pulse signal P controls the switching timing in the switching element 62c1. As a result, the duty ratio of said drive pulse signal is decreased. That is, the inverter 62 is controlled by the pulse signal P such that the duty ratio of the drive pulse signal to be output is decreased, thus causing the luminance of the backlight 61 to decrease down to a predetermined luminance.

Thus, when displaying an image by means of a video signal that displays a black belt above and below the image to be viewed, such as a letter box type video signal used for the movie image, it is possible to automatically adjust the luminance of the screen of the LCD panel 40 to a luminance suitable for viewing said movie image, by lowering the luminance of the backlight down to a predetermined luminance. Furthermore, according to the configuration of this invention, a processing for reducing the gray scale value of a video signal is not required to lower the luminance of the screen of the LCD panel 40. This eliminates improperly narrowed gray scale value range, and basically allows displaying the image based on an input video signal as it is on the LCD panel 40, thus making it possible to reproduce faithfully the original gray scale of the input video signal on the screen.

1. An LCD television comprising
an LCD panel with a predetermined aspect ratio and whose display surface is formed by a plurality of pixels;
a backlight that is disposed behind said LCD panel and illuminating the display surface of said LCD panel from behind;
an inverter to light said backlight at a predetermined luminance by applying a voltage to said backlight;
a video signal processing circuit to perform a predetermined signal processing for an input video signal;
an LCD drive circuit to display an image on said LCD panel based on said video signal; and
a microcomputer to control each of said components, wherein:
said backlight is a fluorescent lamp;
said video signal processing circuit is equipped with a black belt detection circuit to detect a black belt added above and below a landscape image with an aspect ratio different from said LCD panel, based on the degree of change in luminance of each pixel detected by scanning a predetermined vertical scanning lines in a video signal for one frame;
said microcomputer generates a pulse signal with a predetermined duty ratio to cause said inverter to lower the luminance of the fluorescent lamp, and sends this pulse signal to said inverter, when said black belt is detected by the black detection circuit; and
said inverter decreases the luminance of said fluorescent lamp down to a luminance suitable for viewing an image with said black belt added above and below the image, by changing the output of an AC voltage supplied to the fluorescent lamp, based on said pulse signal sent from the microcomputer.

2. An LCD television of claim 1 comprising
a tuner,
an RGB signal generation circuit,
an LCD drive circuit,
an LCD panel,
a microcomputer, and
a backlight unit,
wherein
said LCD drive circuit further comprises:
a pixel number conversion circuit that inputs RGB signals from said RCB signal generation circuit and generates RGB signals for one frame to be displayed on the LCD panel, while performing a scaling processing for the RGB signals;
an image quality adjustment circuit to make the adjustments of brightness, contrast, black balance, and white balance for the RGB signals;
an output processing circuit that generates a control signal voltage based on a synchronization signal and said RGB signals, and drives an LCD panel for R, an LCD panel for G, and an LCD panel for B according to pixel and color by means of said control signal voltage; and
a frame memory in which to store the RGB signals for one frame as pixel information.

3. A backlight control device that is disposed at a predetermined position in an LCD panel and illuminates said LCD panel from behind, comprising:
a backlight control circuit that changes the luminance of said backlight at a predetermined degree, when displaying a landscape image with an aspect ratio different from said LCD panel and with a black belt added above and below the image.

4. A backlight control device according to claim 3, wherein:
said backlight control circuit is equipped with a black belt detection circuit to detect said black belt, and scans a predetermined vertical scanning lines to detect the luminance of each pixel, and then determines whether or not said black belt is included in a video signal, based on the degree of change in the detected luminance between pixels.

5. A backlight control device according to claim 4, wherein:
said backlight control circuit is further equipped with a microcomputer and an inverter;
said microcomputer generate a control signal to lower the luminance of the backlight, and sends this signal to said inverter, when said black belt is detected by said black belt detection circuit; and
said inverter decreases the luminance of the backlight based on said control signal.

6. A backlight control device according to claim 5, wherein:
said microcomputer generates a pulse signal with a predetermined duty ratio when said black belt is detected by said black belt detection circuit; and
said inverter decreases the luminance of said backlight by changing the output of an AC voltage to be supplied to the backlight, based on said pulse signal.

7. A backlight control device according to claim 3, wherein said backlight is a fluorescent lamp.

8. A backlight control device according to claim 3 that controls the backlight of an LCD television comprising
a tuner,
an RGB signal generation circuit,
an LCD drive circuit,
an LCD panel,
a microcomputer, and
a backlight unit,
wherein
said LCD drive circuit further comprises:
a pixel number conversion circuit that inputs RGB signals from said RCB signal generation circuit and generates RGB signals for one frame to be displayed on the LCD panel, while performing a scaling processing for the RGB signals;
an image quality adjustment circuit to make the adjustments of brightness, contrast, black balance, and white balance for the RGB signals;
an output processing circuit that generates a control signal voltage based on a synchronization signal and said RGB signals, and drives an LCD panel for R, an LCD panel for G, and an LCD panel for B according to pixel and color by means of said control signal voltage; and
a frame memory in which to store the RGB signals for one frame as pixel information.

9. A backlight control device according to claim 8, wherein said inverter lights said backlight by converting an DC voltage to an AC voltage and then supplying said AC voltage to said backlight.

10. A backlight control device according to claim 9, wherein:
the inverter is connected to the microcomputer from which the inverter receives a pulse signal as a control signal, and changes the duty ratio of the AC voltage to be applied to the backlight based on said pulse signal.

11. A backlight control device according to claim 10, wherein:
in order to change the luminance of the backlight, said microcomputer sends a pulse signal P as a control signal for the inverter to the switching circuit of the inverter, and said switching circuit provides a control signal to the inverter that changes the timing at which the switching element is switched, so as to change the duty ratio of said drive pulse signal.

12. A backlight control device according to claim 8, wherein:
said black belt detection circuit scans a predetermined vertical scanning lines for said RGB data for one frame to obtain the luminance of each pixel, and if the luminance of a predetermined number of pixels from the top and bottom of the screen respectively is detected to be “0” or less than a predetermine threshold value approximate to zero in a predetermined number of vertical scanning lines, then generates a black belt detection signal and outputs this signal to said microcomputer.

13. A backlight control device according to claim 8, wherein said black belt detection circuit detect said black belt by detecting an edge appearing at the border between the black belt and the image to be viewed.

14. A backlight control device according to claim 13, wherein said black belt detection circuit detects said edge at a predetermined position at in the top and bottom area of the screen, based on the degree of change in luminance in scanning a predetermined number of vertical scanning lines.

15. A backlight control device according to claim 13, wherein said black belt detection circuit uses an edge filter to detect the edge.

16. A backlight control device according to claim 13, wherein:
a “standard mode” and a “movie mode” are provided as the modes for specifying the luminance of the LCD panel the viewer can set, and a signal corresponding to said black belt detection signal is sent when said movie mode is set via the remote control or operation panel.

17. A backlight control device according to claim 8, wherein:
said inverter is equipped with an oscillating circuit, a waveform composing circuit, and a switching circuit, and obtains an DC voltage converted from a utility AC voltage, composes said DC voltage and an oscillation signal of a predetermine frequency generated by said oscillation circuit, in said waveform composing circuit, and then converts a DC voltage input from said switching circuit to a drive pulse signal, and output this signal to the backlight.

18. A method of controlling a backlight that is disposed at a predetermined position in an LCD panel and illuminates said LCD panel from behind, comprising:
changing the luminance of said backlight at a predetermine degree when displaying a landscape image with an aspect ratio different from said LCD panel and with a black belt added above and below the image, on said LCD panel.
